(19) United States
(12) Patent Application Publication
(10) Pub. No.: US 2014/0026025 A1
(43) Pub. Date: Jan. 23, 2014

(54) SYSTEM AND METHOD FOR COLLABORATING OVER A COMMUNICATIONS NETWORK

(71) Applicant: KWIK CV PTY LIMITED, Sydney (AU)

(72) Inventor: Neil SMITH, Sydney (AU)

(73) Assignee: KWIK CV PTY LIMITED, Sydney (AU)

(21) Appl. No.: 13/908,104

(22) Filed: Jun. 3, 2013

(30) Foreign Application Priority Data
Jun. 1, 2012 (AU) 2012902281
Aug. 15, 2012 (AU) 2012903499

(51) Int. Cl. G06F 17/30; G06F 17/24

(52) U.S. Cl. CPC G06F 17/30165; G06F 17/241
USPC 715/230; 707/608

(57) ABSTRACT

A method for collaborating on an electronic document over a communications network comprising: storing an image of a portion of the electronic document; communicating an instance of the document image to a client terminal for rendering by a browser interface, responsive to receiving a request from a collaborator; receiving annotation information indicative of an annotation made by the collaborator in relation to the rendered document image instance via the browser interface; and storing the annotation information.

### FIELD OF THE INVENTION

The present invention relates generally to systems and methods for collaborating over a network and more particularly, but by no means exclusively, to techniques for reviewing and annotating electronic documents over the Internet.

### BACKGROUND OF THE INVENTION

The wide-spread availability of broadband Internet has brought with it numerous advantages, one of which being the ability for parties separated by geographical distances to collaborate over the Internet.

Online collaboration can take many forms and there are a number of software packages which currently provide varying degrees of collaboration functionality. For example, the well-known “Skype®” software (see URL http://www.skype.com) allows remotely located parties who have installed Skype software on their respective computer terminals (and have the necessary communication hardware such as a microphone and video camera) to conduct a video and/or audio conference call making use of IP telephony.

Certain software packages also provide the ability for remotely located parties to collaborate on a document, for example to have an online discussion during which the document is displayed. One such package is the “CoToMeeting” software package (see URL http://gotomeeting.co.uk) which allows a party who has scheduled an online meeting to share their display with other parties (i.e. via their respective web browsers), for collaborating on a document which is open on their display. However, the capabilities of such software packages are limited. For example, typically only one of the parties can have control of the document at any one time for making annotations or comments thereto, which may significantly slow down the collaboration process. Such techniques are also particularly bandwidth intensive due to the data required to be transmitted to each party for replicating the coordinator's screen. Furthermore, like the IP telephony systems, these applications require dedicated software (and in some instances hardware) to be installed on each of the user computer terminals in order to participate in the collaboration session. This may preclude certain potential users from being able to participate in the collaboration session, for example if they are attempting to access the session from an Internet café or within a business environment which prohibits third party software from being installed on their computer (e.g. for security reasons).

It would be advantageous if there was provided a method for online collaboration on a document that overcomes at least some of the deficiencies discussed above.

### SUMMARY OF THE INVENTION

In accordance with a first aspect of the present invention there is provided a method for collaborating on an electronic document over a communications network comprising:
storing an image of a portion of the electronic document;
communicating an instance of the document image to a client terminal for rendering by a browser interface, responsive to receiving a request from a collaborator;
receiving annotation information indicative of an annotation made by the collaborator in relation to the rendered document image instance via the browser interface; and
storing the annotation information.

In an embodiment the image portion comprises a page, sheet, chart or slide of the electronic document.

In an embodiment the annotation is made using an input device provided by the client terminal.

In an embodiment the input device is operable to draw the annotation on an annotatable region of the browser interface overlaying the rendered image portion.

In an embodiment the annotatable region is defined in HTML code with height and width attributes and wherein the annotation information comprises a location of the annotation on the annotatable region.

In an embodiment the annotation information comprises a representation of the drawn annotation.

In an embodiment the annotation comprises comments related to the rendered image and/or annotation entered as text.

In an embodiment the method further comprises presenting the image portion in a webpage displayable by the browser interface.

In an embodiment the webpage is served to the collaborator in response to the collaborator accessing a unique URL assigned to the collaborator.

In an embodiment the method further comprises communicating the unique URL to the collaborator in an electronic message by or on behalf of an initiating collaborator that provided the electronic document for collaboration.

In an embodiment the method further comprises allowing the initiating collaborator to set one or more access control conditions related to access to or interaction with the webpage.

In an embodiment the access control conditions comprise a time period during which the webpage will be accessible.

In an embodiment the method further comprises storing the annotation information in association with an identifier of the collaborator as determined from the unique URL used to access the webpage.

In an embodiment the annotation information is stored in a record comprising one or more of the following: a timestamp at which the image instance was communicated to the browser interface; a timestamp at which the collaborator annotation was recorded; a timestamp at which the collaborator finished viewing the webpage; a number of times the browser accessed the webpage; and an IP address of the client terminal operating the browser interface.

In an embodiment the method further comprises communicating a second instance of the image portion to another collaborator for rendering on a respective browser interface.

In an embodiment the method further comprises communicating the annotation information generated by the first collaborator to the browser interface of the other collaborator for replicating the annotations made by the first collaborator in respect of the first image instance.

In an embodiment the annotation information is processed by the browser interface of the other collaborator such that the annotations made in relation to the first image instance are overlayed onto the second image instance.

In an embodiment the method further comprises receiving and storing annotation information generated by the other collaborator in respect of the second image instance in the image record.

In an embodiment the annotation information of the first collaborator is communicated to the other collaborator in real time over a bi-directional communications channel.

In an embodiment the annotation information is communicated by way of a web server implementing a server-push technology.

In an embodiment the server implements one or more of a server-sent events (SSE), websockets or AJAX based techniques for facilitating the real time bi-directional communication.

In an embodiment the method further comprises allowing one of the collaborators to upload an electronic file via the webpage, the file being subsequently made available to other selected collaborators for collaboration via the respective webpages.

In an embodiment the method further comprises adding a digital watermark to the file for enabling tracking and/or authentication.

In an embodiment the electronic document comprises graphical and/or textual content.

In accordance with a second aspect of the present invention there is provided a collaboration system comprising:
a data repository operable to store an image of a portion of an electronic document to be collaborated on;
a server computer operable to:
   communicate an instance of the document image to a client terminal for rendering by a browser interface operating thereon, responsive to receiving a request from a collaborator; and
   receive annotation information indicative of an annotation made by the collaborator in relation to the rendered image via the browser interface for storing in an image record associated with the electronic document.

In an embodiment the image portion comprises a page, sheet, chart or slide of the electronic document.

In an embodiment the annotation is made using an input device provided by the client terminal.

In an embodiment the input device is operable to draw the annotation on an annotatable region of the browser interface overlaying the rendered image portion.

In an embodiment the server is operable to present the image portion in a webpage displayable by the browser interface.

In an embodiment the webpage is served to the collaborator in response to the collaborator accessing a unique URL assigned to the collaborator.

In accordance with a third aspect of the present invention there is provided an electronic collaboration method comprising:
receiving text to be collaborated on from a user;
presenting a webpage associated with the work to a browser of a collaborator, the webpage displaying the text in an editable text region thereof and being presented to the browser responsive to the collaborator accessing a unique URL provided to the collaborator; and
storing edits made to the text by the collaborator.

In an embodiment the unique URL is associated with an identity of the collaborator such that the edits are stored in association with the collaborator identity.

In an embodiment the unique URL is provided in an electronic collaboration request message sent to the collaborator by or on behalf of the user.

In an embodiment the method further comprises presenting the webpage to other collaborators via respective unique URLs.

In an embodiment the method further comprises storing edits made to the text by the other collaborators in association with their respective identities as determined from the unique URL used to access the webpage.

In an embodiment text displayed in the editable region is broken into predefined editable blocks such that only one predefined block of text is editable by one of the collaborators at any one time.

In an embodiment the predefined blocks consist of one of a word, sentence, paragraph or the entire text included in the editable region.

In an embodiment the method further comprises in response to one of the collaborators selecting a particular block of the text displaying the selected block in a locked state such that it is unable to be selected by the other collaborators until the edits have been completed.

In an embodiment the method further comprises storing a version of each edit made to a block of text.

In an embodiment the method further comprises allowing collaborators to edit the text so as to revert to an earlier version of the text.

In an embodiment the method further comprises updating the editable region in response to an edit made by a collaborator such that the edited text is viewable by each of the other collaborators via the webpage displayed on their respective browsers.

In an embodiment the edits are shown in markup.

In an embodiment the text is included in a document uploaded by the user and wherein the method further comprises parsing the document to extract the text for display on the webpage.

In an embodiment the method further comprises parsing a HTML string to extract the text. In an embodiment the method further comprises parsing the document/HTML to identify the predefined blocks.

In accordance with a fourth aspect of the present invention there is provided a server system for facilitating electronic collaboration comprising:
a web application arranged to receive text to be collaborated on from a user;
a page serving module operable to serve a webpage associated with the work to a browser of a collaborator, the webpage arranged to display the text in an editable text region thereof and being presented by the page serving module responsive to the collaborator accessing a URL uniquely assigned to the collaborator; and
a storage module operable to store edits made to the text by the collaborator.

In an embodiment the unique URL is associated with an identity of the collaborator such that the edits are stored by the storage module in association with the collaborator identity.

In an embodiment the web application is further arranged to communicate the URL to the collaborator in an electronic message using address details provided by the user.

In an embodiment the system is further arranged to present the webpage to other collaborators via respective unique URLs.

In an embodiment the system is further arranged to store edits made to the text by the other collaborators in association with their respective identities as determined from the unique URL used to access the webpage.

In an embodiment the system is further arranged to parse the text into predefined editable blocks such that only one predefined block of text is editable by one of the collaborators at any one time.

In an embodiment the predefined blocks consist of one of a word, sentence, paragraph or the entire text included in the editable region.

In an embodiment the system is further arranged to store a version of each edit made to a block of text.

In accordance with a fifth aspect of the present invention there is provided an electronic collaboration method comprising:
storing an image of a portion of a document for collaboration;
creating a webpage for displaying the image in an annotatable region thereof;
determining at least one collaborator for collaborating on the document and assigning each collaborator a unique URL for accessing the webpage;
allowing the collaborators to make an annotation within the annotatable region using a function provided by the webpage, such that each annotation is stored in association with an identity of the collaborator as determined from the unique URL used to access the webpage.

In an embodiment the method further comprises additionally storing the annotation in association with a location within the annotatable region that the annotation was made.

In accordance with a sixth aspect there is provided a non-transitory computer readable medium storing a computer program which, when implemented by a server computer, is operable to cause the server computer to carry out the method as described in accordance with the first, third or fifth aspects.

In the context of the present specification the term ‘electronic document’ is to be construed in a broad sense and will be understood to include any form of text and/or graphic based document. Non-limiting examples include slides, drawings, charts, and the like.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic of a system for implementing an embodiment of the present invention;

FIG. 2 is a diagram illustrating an upload process, in accordance with an embodiment;

FIG. 3 is a diagram illustrating an invite processing process, in accordance with an embodiment;

FIG. 4 is a diagram illustrating an independent collaboration process, in accordance with an embodiment;

FIG. 5 is an example screen shot of a document image rendered by a participant web browser;

FIG. 6 is an example screen shot of an annotation made to the document image shown in FIG. 5;

FIG. 7 is a diagram illustrating a shared collaboration process, in accordance with an embodiment;

FIG. 8 is an example screen shot of a reporting interface, in accordance with an embodiment; and

FIG. 9 is a diagram illustrating a process flow for using a notes tool, in accordance with an embodiment.

### DETAILED DESCRIPTION OF PREFERRED EMBODIMENTS

Embodiments described herein relate to techniques for allowing parties to collaborate on an electronic document over the Internet without the need to install any dedicated hardware or software (e.g. plug-ins) on their computer terminals for facilitating the collaboration. Instead, embodiments allow for the collaboration process to be carried out using a standard web browser which renders an image of the electronic document (or portion thereof) to be collaborated on, with user interactions made to the rendered image (e.g. annotations and comments) communicated back to a server. The annotations and comments may be communicated to other parties in real time for group collaboration, or simply recorded in a register for subsequent review.

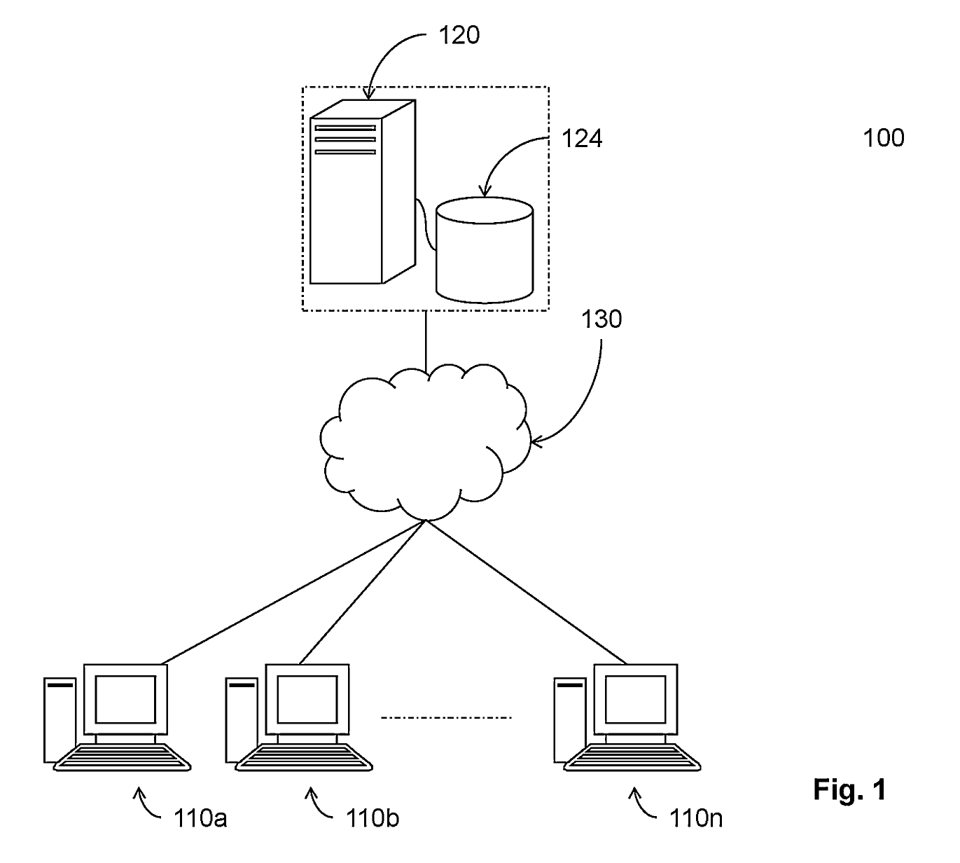

With reference to FIG. 1 there is a shown an example computing architecture 100 in which an embodiment of the invention may be implemented. Specifically, the architecture 100 comprises a plurality of client terminals in the form of general purpose computers 110a to 110n, which each operate a standard web browser such as Internet Explorer, Google Chrome, Safari, or the like.

Each of the client terminals 110a to 110n is configured to communicate with a web application, in this case being implemented by a web server 120 (hereafter ‘collaboration server’) which also maintains a document database 124.

The client terminals 110a to 110n communicate with the collaboration server 120 over a communications network. According to the illustrated embodiment, the communications network is in the form of the Internet 130. Although FIG. 1 depicts an embodiment of an architecture 100 having three client terminals 110 and one server 120, it will be understood that any number of client terminals 110 and servers 120 may be provided.

In more detail, the collaboration server 120 is configured to provide a web interface which is accessible by users of the client terminals 110a to 110n (via their respective web browsers) for facilitating a collaboration process. The collaboration process may take the form of a shared process whereby each of the collaborating parties collaborates on the document at the same time. Alternatively, the collaboration process may take the form of an independent process whereby the collaborating parties review the document independently, with a summary of each of their comments and/or annotations recorded for subsequent review.

Document Upload Process

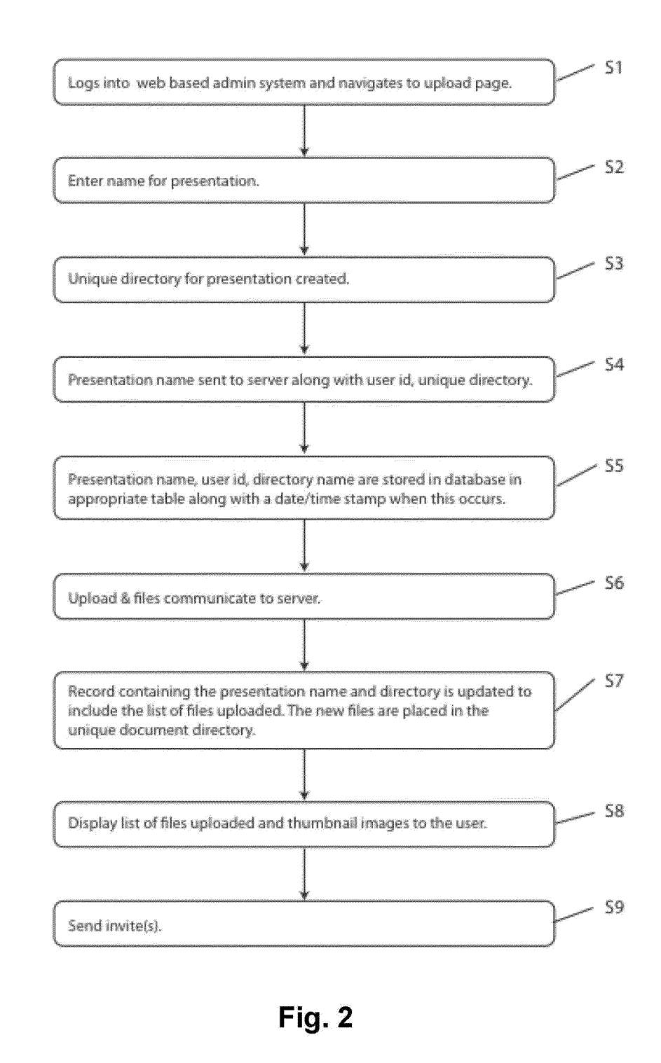

The initial step of any collaboration process (whether shared or independent) involves uploading a document to be collaborated on, as will now be described in detail with reference to FIG. 2. According to the illustrated embodiment, the document is in the form of a slide presentation (e.g. created in Microsoft™PowerPoint™ or Apple™Keynote™) comprising a number of individual slides. It will be understood, however, that embodiments are not so limited and that any suitable form of document comprising any number of individual pages or portions thereof. It will be understood that each of the steps described with reference to FIG. 2 are facilitated by way of the web interface.

The upload process begins with one of the users (the ‘initiating collaborator’) logging in to the web interface using their client terminal 110 and navigating to an ‘upload file’ page thereof (step S1).

At step S2, the initiating collaborator enters a name for a presentation they wish to collaborate on using a text field provided on the page. This causes a unique directory to be created for the presentation in a directory allocated to that user on the web server 120 (step S3).

At steps S4 and S5, the nominated presentation name, unique directory address and a unique identifier for the user are sent to the server 120 for storing in the database 124 in an appropriate table, along with a date/time stamp when this occurs.

At step S6, the initiating collaborator uploads files constituting the individual slides (pages) of the presentation for collaboration from their client terminal 110. According to the embodiment described herein, the files are images (e.g. stored in an appropriate format such as JPEG, PNG, etc.) representative of the individual slides of the slide presentation. The image files may, for example, be created using an export function as will be well understood by persons skilled in the art. According to the illustrated embodiment, the server 120 utilises a JQuery plug-in, such as provided by Uploadify™ (see URL: http://www.uploadify.com) to facilitate the file image upload process. At step S7, the record containing the presentation name and unique directory is updated to include the list of uploaded files. The files are then placed in the unique document directory on the database 124. In an alternative embodiment, the files may be uploaded using the HTML5 filed upload specification which persons skilled in the art will appreciate allows for upload of multiple files, using a drag on drop function within the browser.

Once the files have been uploaded, at step S8, a list of the uploaded files and corresponding thumbnail images of the slides are displayed on the interface for review by the initiating collaborator. At this point the initiating collaborator has the option of changing the order of the images in the presentation, or adding or deleting images. In an embodiment, the interface can allow the initiating collaborator to add images that they have uploaded from past presentations, or may be shown and allowed to add ‘stock’ images that are available for use by any user of the system 100.

At step S9, the initiating collaborator invites other parties (‘participants’) to collaborate on the uploaded presentation. It will be appreciated that the initiating collaborator may also take part in the collaboration session. In an embodiment the web interface allows the initiating collaborator to enter invite details including a name and e-mail address of the participant, the presentation name, the initiating collaborator's name and e-mail address, and a message (if required). The interface may also allow the initiating collaborator to select from a previously entered participant name and email address combination, or to type in the name of a previously entered managed group that itself contains a list of eligible participants. In this regard, the server 120 may be able to interact, and be updated in real time, by third party systems for maintaining up-to-date managed participant lists. The initiating collaborator also has the option at this point of adding access control conditions associated with access of the document. For example, the access control conditions may include a time period during which the document will be available for access by the respective participants, a number of times that the document may be viewed, among others.

The server 120 then creates a record for each of the invited participants in the unique server directory allocated to the initiating collaborator, and e-mails them an invite including a unique URL which is made up of a web address for accessing a webpage that provides the image instance of the document. The URL also comprises a unique participant code which is assigned to that participant and utilised for identification purposes when the page is subsequently accessed. The server 120 also stores a date/time stamp noting when each directory was created. In an embodiment the unique URL may be sent to the participants in other electronic forms such as by way of a text message to their mobile phone (e.g. for viewing on their mobile web browser). According to an embodiment, the invite will include the following information:participant's name, email address, a message entered by the initiating collaborator, the unique URL and the initiating collaborator name. Once the e-mail/text invite has been sent or delivered, a confirmation e-mail is sent to the initiating collaborator.

In an alternative embodiment to that described above, the document upload process may be carried out by e-mail. For example, the initiating collaborator may send an e-mail attaching a copy of the document and including the necessary participant invite details to the web application. The web application subsequently parses the e-mail to extract the necessary information for generating the page and participant invites/records. If the attached collaboration document is not in image format, the web application converts the document to generate the corresponding image(s). In a particular embodiment, the participant details may be provided by way of a CSV file (or the like) attached to the e-mail. As a final step, the web application may generate a message which is sent back to the initiating collaborator which includes a summary of the request and a link to a page which they can access to review the presentation before the system sends the participant invites.

Processing Invites

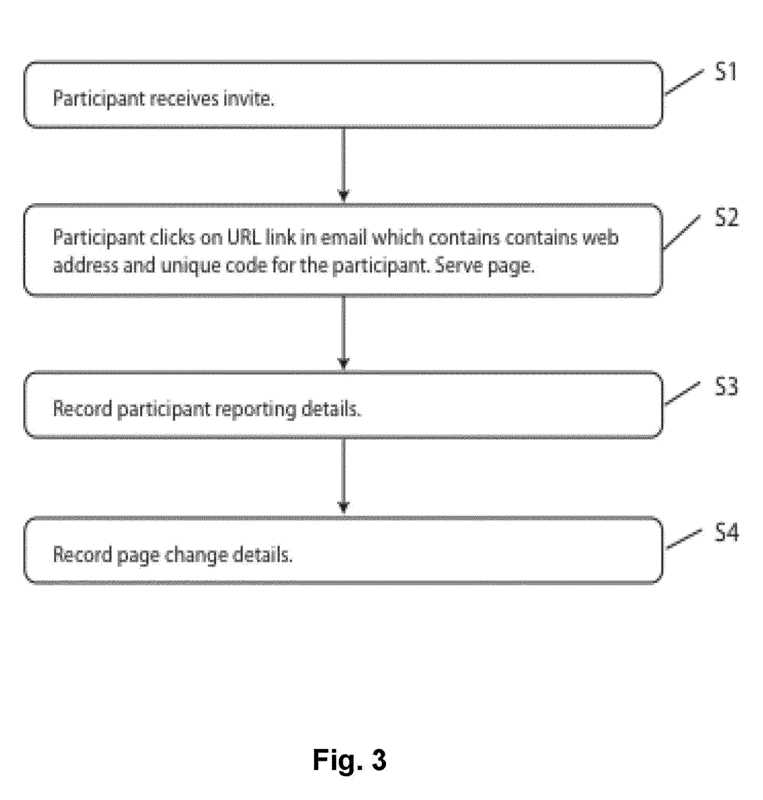

FIG. 3 depicts a process flow for processing invites sent by the initiating collaborator (as per FIG. 2). At step S1, a participant receives the invite via their client terminal 110. They subsequently click on the unique URL link included in the e-mail (step S2). Provided that the participant code identified in the URL is valid and that all of the access control conditions have been satisfied, a web page is served to a web browser of the participant client terminal 110, displaying an image of a first slide. In response to determining that the participant has accessed the link, the web server 120 may also send a confirmation e-mail to the initiating collaborator notifying them that the participant has begun their review.

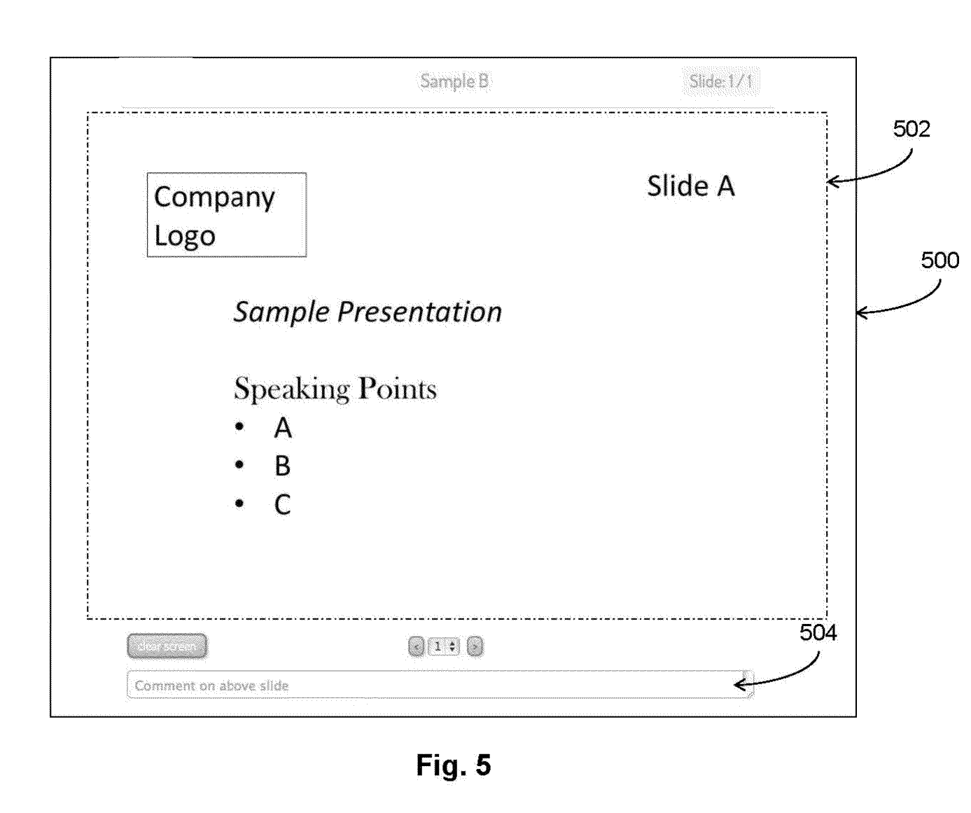

By way of example, FIG. 5 shows an example screen shot 500 of a document image (in this case a slide which forms part of a slide presentation) rendered on a web browser. The slide includes an annotatable region 502 which overlays the image (i.e. in which the participant may make annotations) and a text box 504 where the participant can enter comments.

At step S3, the participant code is matched to the relevant record on the server directory and relevant image instance information is communicated to the server 120 for reporting purposes. According to the illustrated embodiment, the following details are communicated to the server 120: presentation name, IP address of participant client computer, image loaded by web browser, a participant ID (in this case a number which has been allocated by the web server 120) and browser client. Also stored in the record is a unique session code generated for the session and a start time for the session (set to 0). A date and time stamp may also be stored for use in evaluating time related access conditions, as afore-described.

At step S4, responsive to the participant requesting another slide (or portion of the document), the record is updated to reflect a date/time stamp of the request for that particular session. It will be understood that the requested page is served to the web browser in the same manner as described for step S2.

Annotating and Commenting on Documents (Independent Review)

At any time during a collaboration session, a participant may interact with the page served on their web browser to make annotations or comments.

The annotations are handled by way of a scripting tool that is used to draw graphics on a web page. According to the illustrated embodiment, this functionality is handled using a combination of HTML object styled using cascading style sheets and controlled using javascript to thereby allow dynamic scriptable rendering of two dimensional shapes and bitmap images on the interface. An annotatable/drawable region on the presentation interface may be defined in HTML code with height and width attributes and which is supported by the majority of browsers including Internet Explorer, Firefox, Opera, Chrome, and Safari.

So as not to interfere with the display and behaviour of the page when making the annotations, the system 100 may utilise a group of development technologies commonly referred to as AJAX (which is an acronym for Asynchronous JavaScript and XML). AJAX can be implemented on the client side to allow the browser application to send data to, and retrieve data from, the server 120 asynchronously and without the need for full page reloads. It will be understood that websockets (which is a technology providing for bi-directional, full-duplex communications channels over a single TCP connection, as will be understood be persons skilled in the art) and server-sent events may also be used either independently or in combination to facilitate this process, depending on the desired implementation.

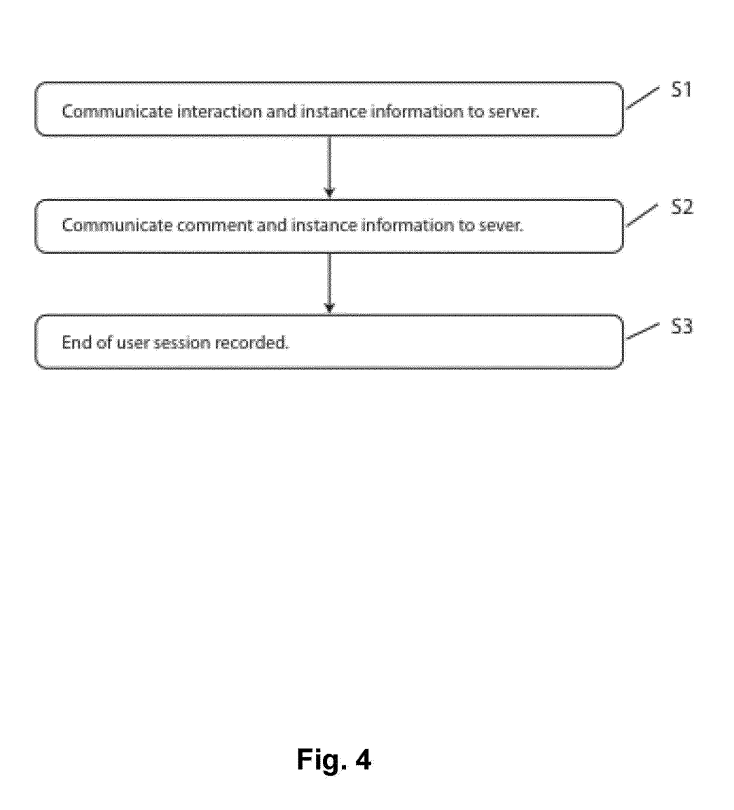

The annotation process will now be described in more detail with reference to FIG. 4.

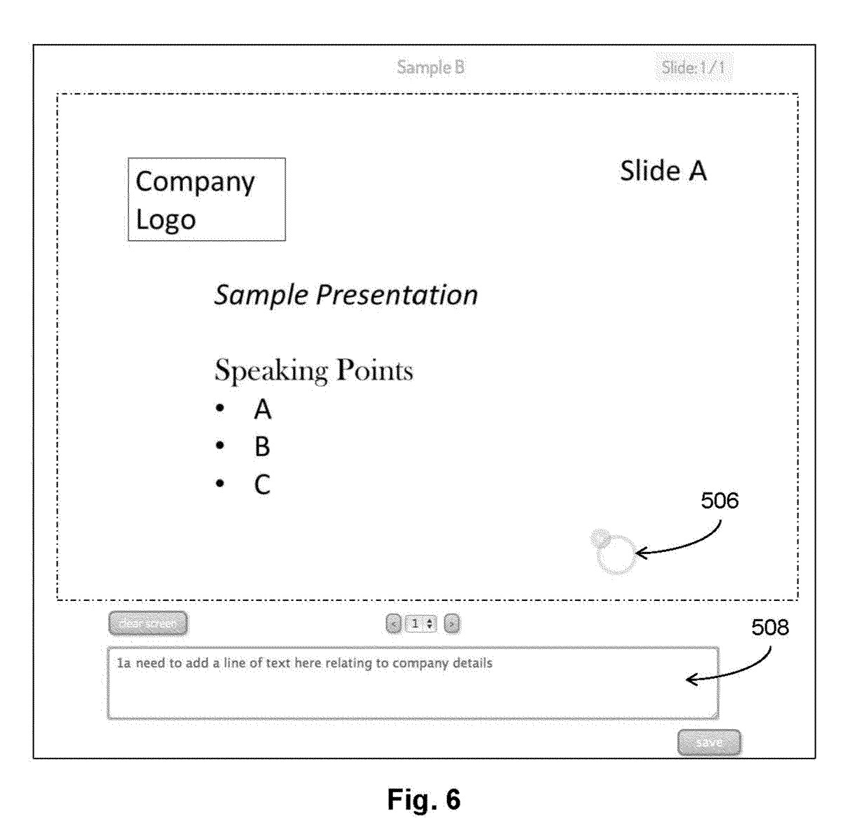

At step S1 of FIG. 4, the javascript operating on a participant's client terminal 110 detects an interaction with the page. The participant may interact with the page via an input device on their client terminal 110, such as a mouse, a keyboard, a stylus, a touch sensitive screen, a trackball, etc. By way of example, FIG. 6 shows a screen shot of the slide previously shown in FIG. 5, on which the participant has mouse-clicked on a lower right hand portion of the annotatable region 502, thereby causing the javascript (in combination with the HTML and CSS) to draw a circle 506 at that location. Annotation information (in this case an X and Y coordinate of the circle location in relation to the image), together with relevant image instance information is subsequently communicated to the server 120 for storing in the corresponding record. According to the illustrated embodiment, the image instance information includes the participant ID, UNIX time (for determining a unique no-repeatable event), presentation name, session number, page number, touch ID (i.e. a unique identifier created to manage and distinguish each new annotation event), IP address, date/time stamp and browser client.

The participant may also add a comment 508 in respect of the image (or annotation) in the text box 504, which is again communicated to the server 120 together with relevant image instance information, for storing in the record (step S2).

The participant also has the option of deleting annotations/comments that they have made in respect of the image during the session. This may be achieved by selecting the clear screen button 510 which causes a message to be communicated to the server 120 for removing each of the annotation and/or comment entries in the corresponding record for that image. Again, a date/time stamp may be recorded for reporting purposes. In an alternative embodiment, each annotation element may have an ‘x’ remove button when the element is moused over, thus allowing the participant to remove a single annotation element (and/or comment in respect thereof).

Once the participant has finished their review, the process ends at step S3. An e-mail may also be sent to the initiating collaborator notifying them that the participant has finished their review. The finish time may also be recorded by the server (which may be determined using a javascript event which determines when the page has been closed or navigated off).

It will be understood that the above process is carried out each time a new slide is requested and viewed by the participant. Furthermore, the same process will apply for each participant who accesses the unique link (although it will be understood that the data communicated back to the server 120 will be recorded in association with different image instance information for reporting purposes).

Annotating and Commenting on Documents (Shared Review)

The server 120 is also configurable to communicate with multiple participants at the same time, such that annotations and comments made by one participant are dynamically communicated to each of the other participants for rendering on their respective web browsers. In this case, the invite sent to the participants by the initiating collaborator may additionally include a date and time for the shared review. The initiating collaborator may also include access control conditions which allow the unique link to be valid only during the scheduled meeting time.

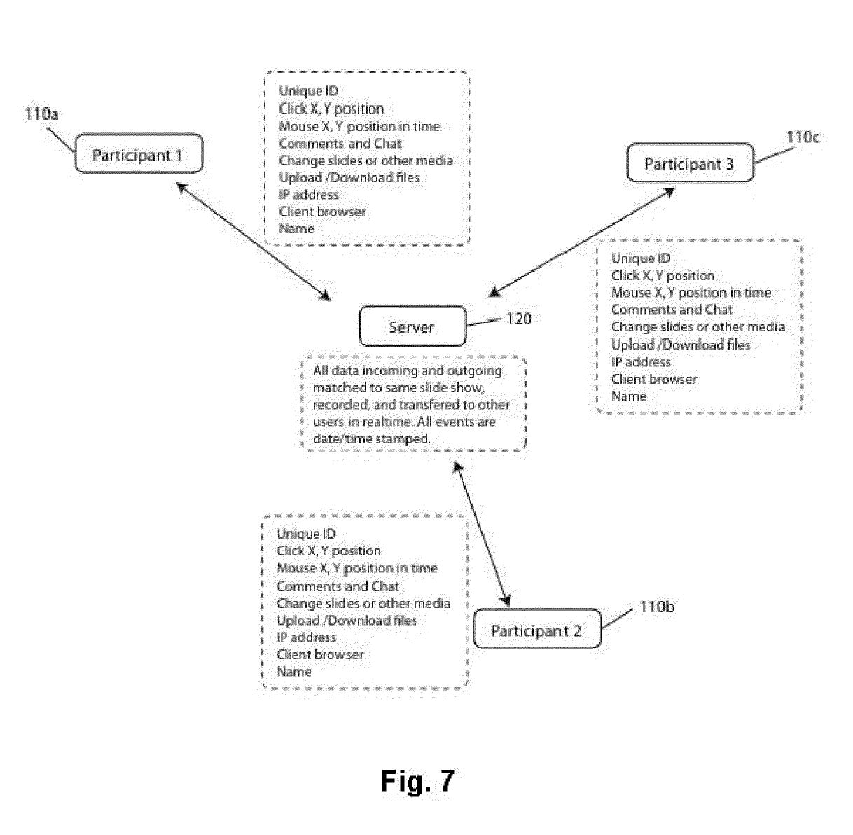

In more detail, and with reference to FIG. 7, the process is facilitated by way of the server 120 and involves receiving and recording incoming annotation information (i.e. annotation co-ordinate and comment information) and instance information from each participant as previously described with reference to FIG. 4. In an embodiment, a co-ordinate position of each participant's cursor may also be communicated and recorded as part of the annotation information. Responsive to receiving this information, the server 120 communicates the recorded annotation to each of the other participants for rendering on the respective web browsers. In an embodiment this involves using javascript operating on the participant web browsers to collect and make use of the annotation information for the appropriate rendering of the information.

In order to facilitate real-time communication of the interaction information between participants the system 100 provides a bi-directional communication channel, together with a server-push technology. In an embodiment, this is achieved using WebSockets (which is a standard developed under HTML 5) and/or server-sent events in combination with AJAX. As persons skilled in the art will appreciate, these technologies allow the server 120 and client terminals 110 to open a bi-directional communication channel so that the annotation information can be pushed back and forth whenever necessary.

In an embodiment the annotation information for each participant may be rendered in a unique colour to allow the participants to readily identify who the annotations/comments belong to.

In a particular embodiment, the initiating collaborator (or another authorised participant taking part in the collaboration session) may have the ability to control when to change the slides. Alternatively, they may allow participants to request slide changes and then open it to those participants to do so (while still maintaining an overall control of the session), or remove control therefrom at anytime. In an alternative embodiment, the system may be configured to allow for any one of the participants to change the slides at any time.

File Upload

While participating in a collaboration session, participants are able to upload a file or files to share with the initiating collaborator and any other participants (i.e. for the case of a shared review). To facilitate the process, the participant who wishes to share a file (hereafter ‘file uploader’) selects a file or files stored on their terminal for uploading to the system (e.g. using a suitable function provided by way of the web page).

In the case of a shared review, uploaded files may be made available to the other participants through a list with thumbnails inside their active web page. In a particular embodiment, the file uploader may choose which of the other participants currently taking place in the shared review can view and download the file(s). Those participants who are not chosen to receive the file(s) will not know the upload action has taken place since no indication will be displayed on their active web page. The uploader may also choose to upload files through a third party file storage system such as “Dropbox” or “Box” (i.e. via an API implemented by such services) if they have an account with these services. Equally, participants with whom the file has shared may also be presented with the option to download the shared file(s) to such a third party service.

Where the file was uploaded as part of an independent review, the file may be made available to initiating collaborator via a reporting page (discussed below), or in an electronic message automatically sent to the initiating collaborator. Again, the initiating collaborator may also be presented with the option of downloading the file(s) to a third party file storage system.

A record of the file transfer is logged and stored by the server 104 for subsequent tracking or analysis. The record may include a list of all participants who viewed and/or download a copy of the file, together with a date/time stamp.

Tracking and Authentication

In some instances the content of a shared presentation may be of a private/confidential nature. In this case, the system may be configured to automatically add a digital watermark to each image file delivered to a collaborator for subsequent tracking and authentication.

The digital watermark may comprise encrypted strings that are represented through byte manipulation of the image or as a character string in the metadata of the file.

The encryption may be operable across multiple file formats readable by the client browsers, including but by no means limited to: JPG, JPEG 2000, PNG, GIF or BMP. The embedded string may be generated dynamically upon a participant request message being received at the server side of the system. The embedded string(s) may contain a relation to or representation of the unique session that is created for the collaborator upon opening a presentation, as previously described. The string(s) may also contain other information which is required in the process of hiding or manipulating the image and to make the detection of the digital watermark more difficult. In such a manner, the removal or modification of the string(s) will show up in forensic investigation since the original data will not match an original watermarked record of the image file stored by the system.

Reporting

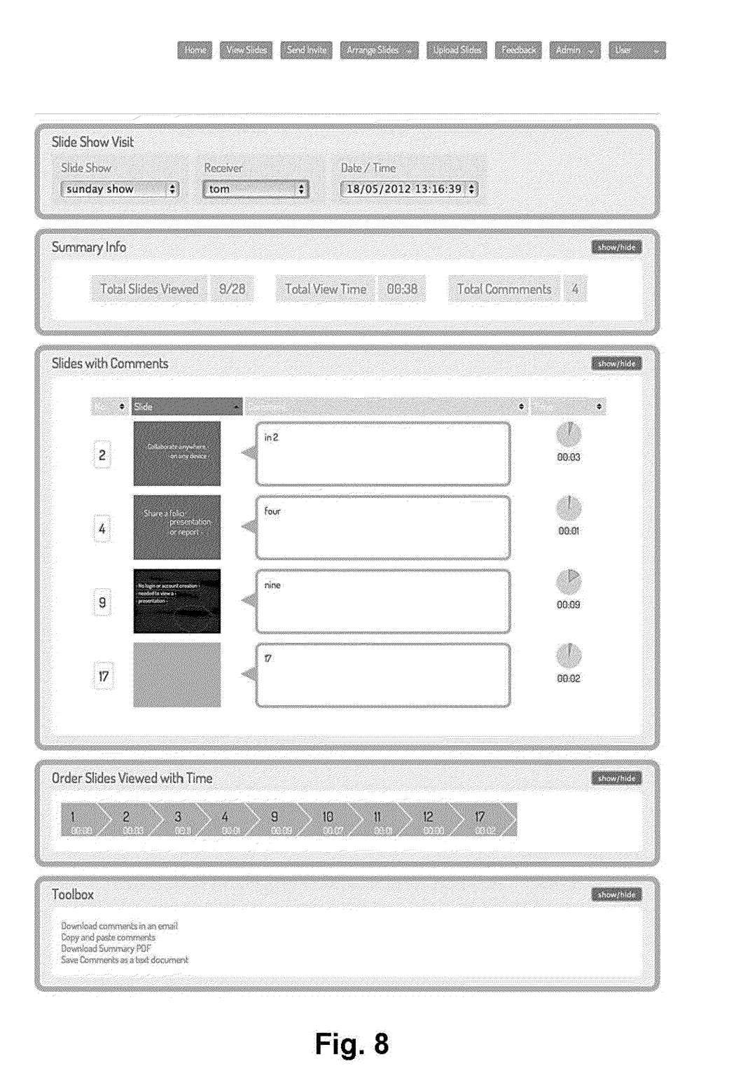

With reference to FIG. 8 there is shown an example screen shot of a reporting page (i.e. provided by the web interface as afore-described) which is viewable by the initiating collaborator for viewing a log of the annotation and image instance information communicated by each of the participant client terminals 110 (irrespective of whether that information was communicated as part of an independent or shared review process).

As can be seen from the example screen shot shown in FIG. 8, the reporting page provides the following information to the initiating collaborator (i.e. as determined from the instance information):
The time/date that each of the pages of the document were accessed by participant;
The time spent on each page as an aggregate (i.e. if a slide is returned to repeatedly);
any comments made by the participant;
slide view order in combination with time for that view instance;
total number of slides viewed in combination with the total number of slides in the presentation;
total time spent viewing the presentation and number of comments made as a total;
For reports that show a slide show with more than a single participant, the aggregates and averages (e.g. time spent on slides, comments, click paths, etc.)

It will be understood that the reporting page may be used to report any information captured during the collaboration session for an individual participant, slide show or across multiple presentations.

An option may be provided on the reporting page for the initiating collaborator to view the interaction information overlayed onto the respective slides (e.g. using canvas elements as will be understood by persons skilled in the art). In addition, an option may be provided for the initiating collaborator to download a summary report of the recorded annotation and/or instance information in a desired file format. For example, the report may be generated by exporting information from the record in a desired file format (e.g. PDF, CSV, TXT, etc.).

The reporting page can also be used to respond to any comments made by the participants as part of their review. In this regard, the reporting page may be updated in real time, thereby allowing the initiating collaborator to view a live log of the incoming annotation and instance information (which may be particularly advantageous for instantaneously responding to any incoming comments during a shared review process).

Presenters Notes Function

According to a particular embodiment the system implements a notes function specifically for use with uploaded slide presentations. The notes function is implemented by software residing on the web server 120 and allows participants to interact with presenter notes (e.g. from PowerPoint or Keynote slide presentations) as part of the collaboration process.

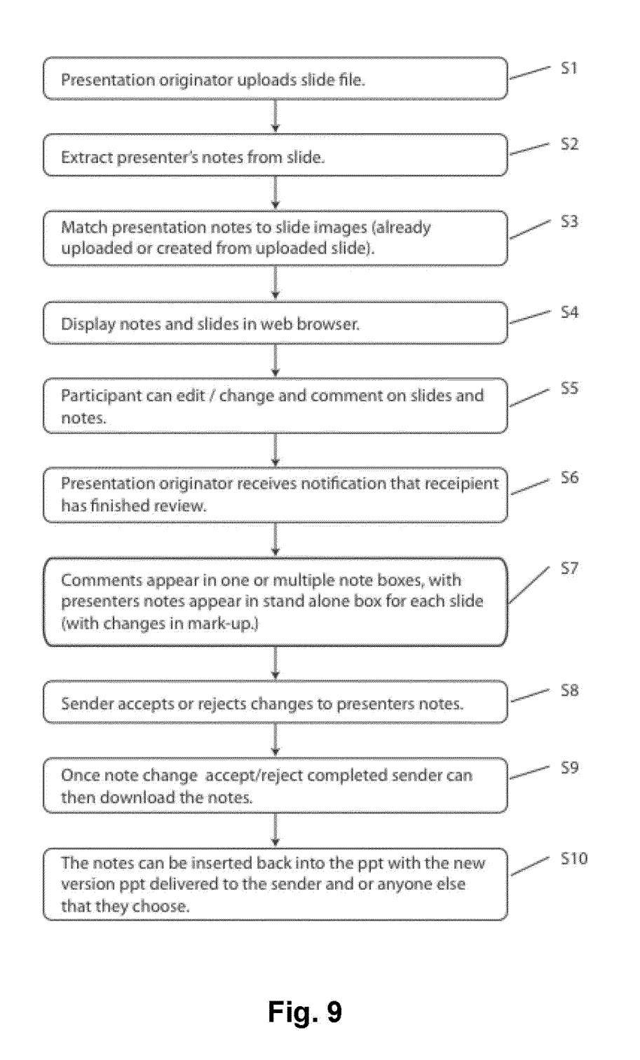

With additional reference to FIG. 9 there is shown a process flow for using the notes function. At step S1, the initiating collaborator uploads a slide show file (i.e. a Microsoft PPT or Keynote file), containing presenter notes. At step S2, extraction software residing on the web server 120 extracts the presenter notes from the slide file. At step S3, the presenter notes are matched to either an already uploaded slide image, or to images of the corresponding slide that are generated on the fly (i.e. by the web server software using a suitable extraction process). During a review process (i.e. as previously described with reference to FIGS. 3 and 4), the notes may be displayed in a dedicated region of the rendered screen for review by a participant. In addition to making annotations and comments, the participant has the option of making edits to the presenter notes (e.g. again using AJAX, websockets and/or server-sent events depending on the technology available on the participant browsers and the desired implementation) with those edits being communicated back to the server as part of the annotation information (step S5).

At step S6, the initiating collaborator receives a notification that the participant has finished their review and at step S7 views the interaction information (including any edits to the notes) in the reporting page. In a particular embodiment, the edits made to the notes may be shown in mark-up in a dedicated text box for each slide. The initiating collaborator may accept or reject changes made by the participant using a review tool provided on the page (step S8). At step S9, the initiating collaborator has the option of downloading the notes to their computer terminal or for injecting back into the slide presentation. For example, the originator can download an updated presentation file with the notes inserted thereon, or with the notes included separately as a text file, Word doc, Pages doc, etc.

Presenting and Annotating Editable Text

As mentioned above, in a particular embodiment the presentation may include a section for displaying text that is editable by the collaborators (whether it be in the form of presenter notes, or otherwise). As for the image file, the text may be presented in an annotatable region within the web page.

In the case of a shared review process, the text displayed within the editable region is broken into predefined editable blocks such that only one predefined block of text is editable by one of the collaborators at any one time. The predefined blocks may consist of, for example, a word, sentence, paragraph or the entire text included in the editable region. Where the text was initially present in a document or HTML string uploaded by the initiating collaborator, the system is configured to parse the document/HTML string to extract and identify the predefined blocks of text for presenting to each of the collaborators.

In response to one of the collaborators selecting a particular block of the text for editing, the same block may be displayed to other collaborators in a locked state such that it is unable to be selected by the other collaborators until the edits have been completed. It will be appreciated that the bi-directional communication of edit information may be carried out in the same manner as for the annotation information.

Again, the unique URL used by the collaborator to access the page is used by the system to determine an identity of the collaborator for recording and presenting those edits to other collaborators. Further, where multiple edits are made to a particular block of text, the system may be configured to store and display versions of each edit for tracking and reversion purposes.

Further Detail of System Configuration

It will be understood that the collaboration server 120 can be any type of computing device that is capable of communicating with the computer terminals 110 and database 124 in the afore-described manner. According to the illustrated embodiment, the server 120 is in the form of a web server which includes typical web server hardware including a processor, motherboard, memory, hard disk and a power supply. The web server 120 also includes an operating system which co-operates with the hardware to provide an environment in which software applications can be executed. In this regard, the hard disk of the server 120 is loaded with a processing module which, under the control of the processor, is operable to implement the web application, interface and database access operations as previously described.

It will be appreciated that the client computer on which the web browser is installed could be any suitable form of network-enabled computing device that is capable of implementing a browser interface. For example, the computing device may be a general purpose computer or a special purpose device including a smart phone, tablet, or the like. Details of such devices (e.g. processor, memory, display, data storage, etc.) are omitted for the sake of clarity.

It will be understood that any suitable computer network may be utilised to facilitate communication between the client terminals 110a to 110n and the collaboration web server 120. For example, the client terminals 110a to 110n could communicate with the collaboration server 120 over a private wide area network (WAN), metropolitan-area network (MAN) or local area network (LAN).

While the above described embodiments utilised javascript, CSS and HTML for facilitating the annotation marker process, it will be understood that other scripting tools could be used for drawing the marker. For example, the annotations could be drawn using a scalable vector graphics (SVG) technique which is an earlier vector-based standard (as opposed to raster-based as used by canvas) or webGL for drawing shapes in browsers.

In an alternative embodiment to that described above, the document images presented to the participants for collaboration may be embedded into text files, for example in external CSS files, to hide the original location of the corresponding images. This provides improved security since the file structure for the original slides is not exposed to the participants. Embedding the images in this manner may also provide faster delivery and allow watermarks to be readily added to the images. The image may, for example, be converted to a 64 bit data uniform resource identifier scheme which persons skilled in the art will appreciate provides a mechanism for including data in-line in web pages as if they were external resources (and allows normally separated elements to be fetched in a single HTTP request for efficiency). It will be understood that this technique may not be limited to images, but extend to the delivery of text or data e.g. from a spread sheet or document.

It can be seen that embodiments of the invention have at least one of the following advantages:
removes hurdles in the exchange of presentations, educational material, updates or notes since there is no need to install dedicated software of plugins for participating in a collaboration or review process;
no need to e-mail files to other participants for collaboration which can often be rejected if the size of the file is large;
allows exact reproductions of the presentations to appear on participant computer terminals operating on different platforms (i.e. irrespective of the fonts installed thereon);
due to the browser based implementation the collaboration is not hindered by firewalls which can be experienced using convention systems that required dedicated software to be installed;
not hindered by locked-down computer systems that stop users installing software or downloading files;
bandwidth efficient due to the minimal amount of information needed to be transferred at anyone time for communicating annotations and comments. This in turn makes the process attractive for use on mobile devices since there is minimal battery power required to participate in a collaboration session;
works on mobile devices that do riot support current Flash-based technology (which is required for many convention collaboration systems);
works across multiple browsers and platforms;
has reporting and tracking built in at the base level making the reporting more useful and richer than conventional systems;
designed to be open in regards to connecting to other applications through API's thus making the system more robust and easier to integrate into users work flows;
no login or account creation required for end users

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for collaborating on an electronic document over a communications network comprising:
storing an image of a portion of the electronic document;
communicating an instance of the electronic document image to a client terminal for rendering by a browser interface, responsive to receiving a request from a collaborator;
receiving annotation information indicative of an annotation made by the collaborator in relation to the rendered document image instance via the browser interface; and
storing the annotation information.

2. A collaboration method in accordance with claim 1, wherein the image portion comprises a page, sheet, chart or slide of the electronic document.

3. A collaboration method in accordance with claim 2, wherein the annotation is made using an input device provided by the client terminal, the input device being operable to draw the annotation on an annotatable region of the browser interface overlaying the rendered image portion.

4. A collaboration method in accordance with claim 3, wherein the annotatable region is defined in HTML code with height and width attributes and wherein the annotation information comprises a location of the annotation on the annotatable region.

5. A collaboration method in accordance with claim 2, wherein the annotation comprises comments related to the rendered image and/or annotation entered as text.

6. A collaboration method in accordance with claim 1, further comprising presenting the image portion in a webpage displayable by the browser interface.

7. A collaboration method in accordance with claim 6, wherein the webpage is served to the collaborator in response to the collaborator accessing a unique URL assigned to the collaborator.

8. A collaboration method in accordance with claim 7, further comprising communicating the unique URL to the collaborator in an electronic message by or on behalf of an initiating collaborator that provided the electronic document for collaboration.

9. A collaboration method in accordance with claim 8, further comprising allowing the initiating collaborator to set one or more access control conditions related to access to or interaction with the webpage.

10. A collaboration method in accordance with claim 9, wherein the access control conditions comprise a time period during which the webpage will be accessible.

11. A collaboration method in accordance with claim 8, further comprising storing the annotation information in association with an identifier of the collaborator as determined from the unique URL used to access the webpage.

12. A collaboration method in accordance with claim 11, wherein the annotation information is stored in a record comprising one or more of the following: a timestamp at which the image instance was communicated to the browser interface; a timestamp at which the collaborator annotation was recorded; a timestamp at which the collaborator finished viewing the webpage; a number of times the browser accessed the webpage; and an IP address of the client terminal operating the browser interface.

13. A collaboration method in accordance with claim 1, further comprising communicating a second instance of the image portion to another collaborator for rendering on a respective browser interface.

14. A collaboration method in accordance with claim 13, further comprising communicating the annotation information generated by the first collaborator to the browser interface of the other collaborator for replicating the annotations made by the first collaborator in respect of the first image instance.

15. A collaboration method in accordance with claim 14, wherein the annotation information is processed by the browser interface of the other collaborator such that the annotations made in relation to the first image instance are overlayed onto the second image instance.

16. A collaboration method in accordance with claim 13, further comprising receiving and storing annotation information generated by the other collaborator in respect of the second image instance in the image record.

17. A collaboration method in accordance with claim 13, wherein the annotation information of the first collaborator is communicated to the other collaborator in real time over a bi-directional communications channel.

18. A collaboration method in accordance with claim 17, wherein the annotation information is communicated by way of a web server implementing a server-push technology.

19. A collaboration method in accordance with claim 18, wherein the server implements one or more of a server-sent events (SSE), websockets or AJAX based techniques for facilitating the real time bi-directional communication.

20. A collaboration system comprising:
a data repository operable to store an image of a portion of an electronic document to be collaborated on;
a server computer operable to:
communicate an instance of the document image to a client terminal for rendering by a browser interface operating thereon, responsive to receiving a request from a collaborator; and
receive annotation information indicative of an annotation made by the collaborator in relation to the rendered image via the browser interface for storing in an image record associated with the electronic document.

21. A collaboration system in accordance with claim 20, wherein the image portion comprises a page, sheet, chart or slide of the electronic document.

22. A collaboration system in accordance with claim 21, wherein the annotation is made using an input device provided by the client terminal, the input device being operable to draw the annotation on an annotatable region of the browser interface overlaying the rendered image portion.

23. A collaboration system in accordance with claim 20, wherein the server is operable to present the image portion in a webpage displayable by the browser interface.

24. An electronic collaboration method comprising:
receiving text of a work to be collaborated on from a user;
presenting a webpage associated with the work to a browser of a collaborator, the webpage displaying the text in an editable text region thereof and being presented to the browser responsive to the collaborator accessing a unique URL provided to the collaborator; and
storing edits made to the text by the collaborator.

25. A server system for facilitating electronic collaboration comprising:
a web application arranged to receive text to be collaborated on from a user;
a page serving module operable to serve a webpage associated with the work to a browser of a collaborator, the webpage arranged to display the text in an editable text region thereof and being presented by the page serving module responsive to the collaborator accessing a URL uniquely assigned to the collaborator; and
a storage module operable to store edits made to the text by the collaborator.

26. A server system in accordance with claim 25, wherein the unique URL is associated with an identity of the collaborator such that the edits are stored by the storage module in association with the collaborator identity.

27. A server system in accordance with claim 26, wherein the web application is further arranged to communicate the URL to the collaborator in an electronic message using address details provided by the user.

28. A server system in accordance with claim 26, further comprising presenting the webpage to other collaborators via respective unique URLs.

29. A server system in accordance with claim 28, further arranged to store edits made to the text by the other collaborators in association with their respective identities as determined from the unique URL used to access the webpage.

30. A server system in accordance with claim 28, being further arranged to parse the text into predefined editable blocks such that only one predefined block of text is editable by one of the collaborators at any one time.

31. A server system in accordance with claim 30, wherein the predefined blocks consist of one of a word, sentence, paragraph or the entire text included in the editable region.

32. A server system in accordance with claim 30, further comprising storing a version of each edit made to a block of text.
